(19) United States
(12) Patent Application Publication
(10) Pub. No.: US 2023/0063602 A1
(43) Pub. Date: Mar. 2, 2023

(54) COIL COMPONENT

(71) Applicant: TDK CORPORATION, Tokyo (JP)

(72) Inventors: Hokuto EDA, Tokyo (JP); Hitoshi OHKUBO, Tokyo (JP); Masazumi ARATA, Tokyo (JP); Masataro SAITO, Tokyo (JP); Kohei TAKAHASHI, Tokyo (JP); Takamasa IWASAKI, Tokyo (JP)

(73) Assignees: TDK CORPORATION, Tokyo (JP); TDK CORPORATION, Tokyo (JP)

(21) Appl. No.: 17/898,729

(22) Filed: Aug. 30, 2022

(30) Foreign Application Priority Data
Sep. 1, 2021 (JP) 2021-142445

(51) Int. Cl. H01F 1/14; H01F 5/06; H01F 5/04

(52) U.S. Cl. CPC H01F 1/14; H01F 5/06; H01F 5/04

(57) ABSTRACT

In the coil component, the coupling coefficient can be adjusted by the magnetic sheet and the insulator interposed between the pair of coils. For example, by increasing the magnetic permeability of the magnetic sheet so that the magnetic flux generated in the coil easily passes through the magnetic sheet, the coupling coefficient decreases. In the coil component, the coupling coefficient can be adjusted while the thickness of the element body is suppressed.

### CROSS-REFERENCE TO RELATED APPLICATIONS

This application is based upon and claims the benefit of priority from Japanese Patent Application No. 2021-142445, filed on 1 Sep. 2021, the entire contents of which are incorporated herein by reference.

### TECHNICAL FIELD

The present disclosure relates to a coil component.

### BACKGROUND

Well known in the art is a coil component in which a pair of coils are overlapped with each other in a coil axis direction. Japanese Patent Application Publication No. 2018-137421 discloses a coil component in which a PCB substrate is interposed between a pair of coils, and a high coupling coefficient is obtained by the PCB substrate which is a non-magnetic body.

### SUMMARY

The above-described coil component may be required to have a coupling coefficient falling within a predetermined range depending on its use. In the case where the PCB substrate is interposed between the pair of coils, the coupling coefficient can be reduced by increasing the thickness of the PCB substrate. However, the element body becomes thick and the size of the element is increased. The inventors have made intensive studies on a technique for adjusting the coupling coefficient, and have newly found a technique capable of adjusting the coupling coefficient while suppressing the thickness of the element body.

According to the present disclosure, there is provided a coil component capable of adjusting a coupling coefficient while suppressing a thickness of an element body.

A coil component according to one aspect of the present disclosure includes an element body made of a metal powder-containing resin, a pair of coils provided in the element body, the pair of coils overlap each other in a coil axis direction, and each of the pair of coils has a pair of end portions extending to a surface of the element body, two pairs of external terminals provided on the surface of the element body and connected to the end portions of the pair of coils, respectively, a magnetic sheet provided in the element body and interposed between the pair of coils in the coil axis direction, an insulator interposed between at least one of the pair of coils and the magnetic sheet.

In the coil component, the coupling coefficient is adjusted by the magnetic sheet and the insulator interposed between the pair of coils. For example, by increasing the magnetic permeability of the magnetic sheet so that the magnetic flux generated in the coil easily passes through the magnetic sheet, the coupling coefficient decreases. Therefore, in the coil component, it is possible to adjust the coupling coefficient while suppressing the thickness of the element body.

In the coil component according to another aspect, the magnetic sheet is made of a magnetic material containing magnetic powder and resin.

In the coil component according to another aspect, the magnetic powder of the magnetic sheet has a flat shape.

In the coil component according to another aspect, a thickness of the magnetic sheet is greater than a thickness of a portion of the insulator interposed between the magnetic sheet and the coil.

In the coil component according to another aspect, a magnetic permeability of the magnetic sheet is higher than a magnetic permeability of the element body.

In the coil component according to another aspect, at least one of a portion corresponding to an inner peripheral region of the coil and a portion corresponding to an outer peripheral region of the coil is omitted from the magnetic sheet.

### BRIEF DESCRIPTION OF THE DRAWINGS

FIG. 1 is a schematic perspective view of a coil component according to an embodiment.

FIG. 2 is a view showing the inside of the coil component of FIG. 1.

FIG. 3 is an exploded perspective view of the coil structure shown in FIG. 2.

FIG. 4 is a plan view showing the magnetic sheet shown in FIG. 3.

FIG. 5 is a cross-sectional view taken along line V-V of the element body shown in FIG. 2.

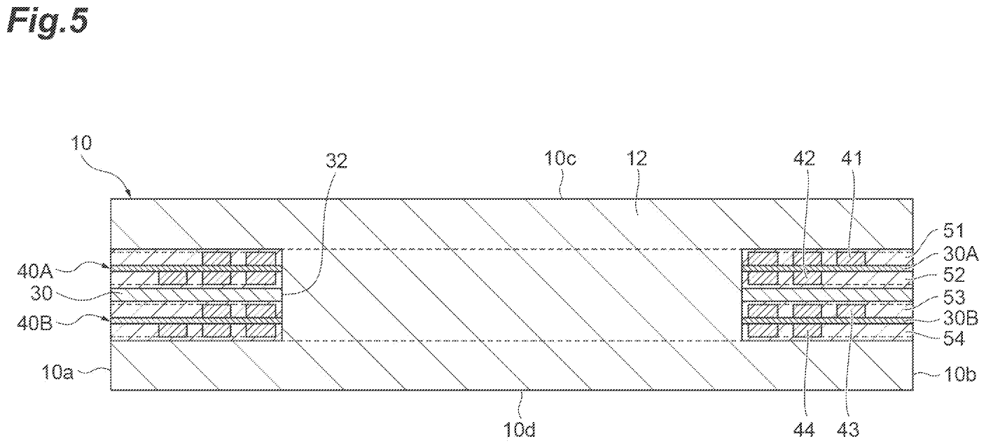

FIG. 6 is a cross-sectional view taken along line VI-VI of the element body shown in FIG. 2.

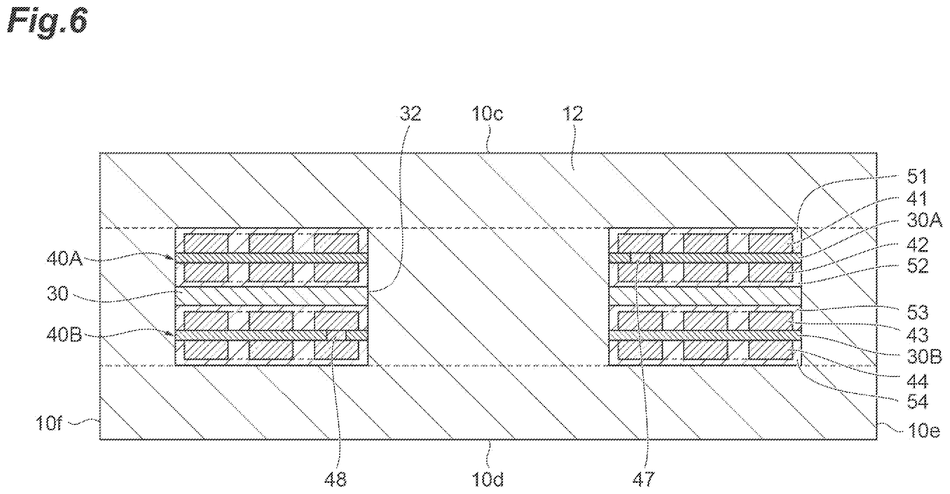

FIG. 7 is an enlarged view of a main part of the cross-sectional view shown in FIG. 6.

### DETAILED DESCRIPTION

Hereinafter, embodiments of the present disclosure will be described in detail with reference to the accompanying drawings. In the description, the same reference numerals are used for the same elements or elements having the same functions, and redundant description will be omitted.

The coil component 1 according to the embodiment is a so-called coupling coil. The coupling coil includes two coils in one element, and can reduce the number of components and the mounting area. The coupling coil can be used as, for example, a smoothing coil of a switching power supply such as a DC/DC converter of various electronic devices.

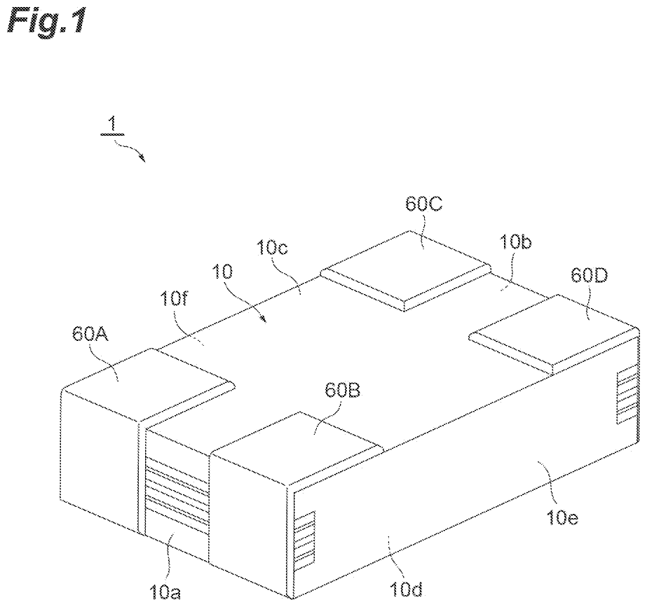

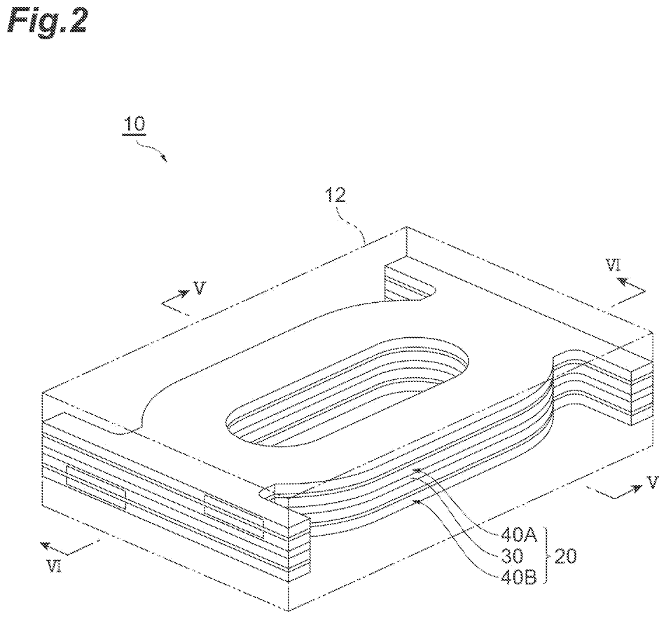

As shown in FIGS. 1 and 2, the coil component 1 includes an element body 10, a coil structure 20 embedded in the element body 10, and two pairs of external terminal electrodes 60A, 60B, 60C, and 60D provided on the element body 10.

The element body 10 has a rectangular parallelepiped outer shape and has six surfaces 10a to 10f. As an example, the element body 10 is designed to have dimensions of long side 2.0 mm, short side 1.25 mm, and height 0.45 mm Among the surfaces 10a to 10f of the element body 10, the end surface 10a and the end surface 10b are parallel to each other, the upper surface 10c and the lower surface 10d are parallel to each other, and the side surface 10e and the side surface 10f are parallel to each other. The upper surface 10c of the element body 10 is a surface facing in parallel to a mounting surface of a mounting substrate on which the coil component 1 is mounted.

The element body 10 is made of a metal magnetic powder-containing resin 12 which is one type of magnetic material. The metal magnetic powder-containing resin 12 contains a metal powder and a resin, and more specifically, is a bound powder in which the metal magnetic powder is bound by a binder resin. The metal magnetic powder of the metal magnetic powder-containing resin 12 is composed of, for example, an iron-nickel alloy (permalloy alloy), carbonyl iron, an amorphous, FeSiCr alloy in amorphous or crystalline state, sendust, or the like. The binder resin is, for example, a thermosetting epoxy resin. In the present embodiment, the content of the metal magnetic powder in the bound powder is 80 to 92 vol % in terms of volume percent, and 95 to 99 wt % in terms of weight percent. From the viewpoint of magnetic properties, the content of the metal magnetic powder in the bound powder may be 85 to 92 vol % in terms of volume percent and 97 to 99 wt % in terms of weight percent. The magnetic powder of the metal magnetic powder-containing resin 12 may be a powder having one type of average particle diameter or may be a mixed powder having a plurality of types of average particle diameters.

The metal magnetic powder-containing resin 12 of the element body 10 integrally covers a coil structure 20 described later. Specifically, the metal magnetic powder-containing resin 12 covers the coil structure 20 from above and below and covers the outer periphery of the coil structure 20. The metal magnetic powder-containing resin 12 fills the inner peripheral region of the coil structure 20.

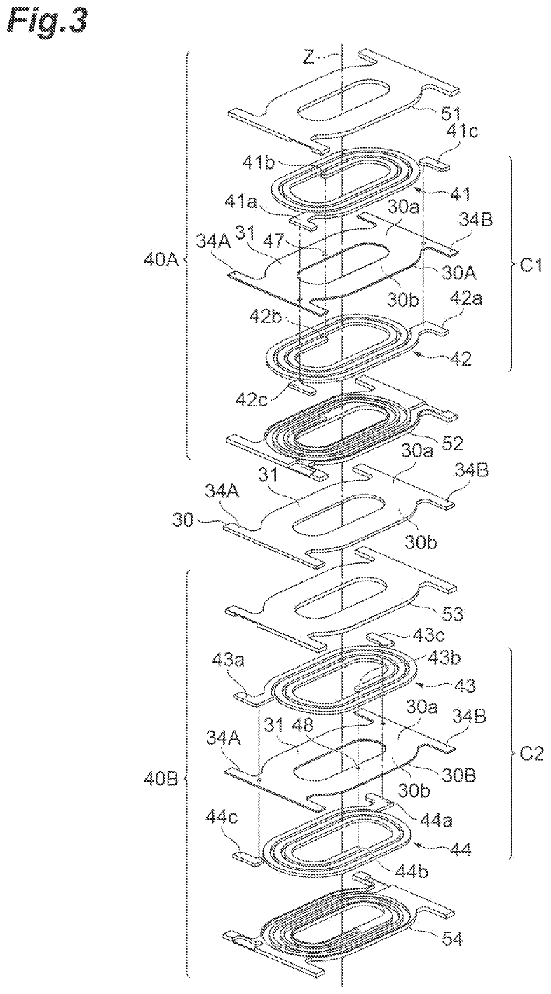

As shown in FIGS. 2 and 3, the coil structure 20 includes a magnetic sheet 30, an upper coil structure 40A provided on the upper side of the magnetic sheet 30, and a lower coil structure 40B provided on the lower side of the magnetic sheet 30. The coil structure 20 is a stacked body in which an upper coil structure 40A, a magnetic sheet 30, and a lower coil structure 40B are stacked in this order, and the magnetic sheet 30 is interposed between the upper coil structure 40A and the lower coil structure 40B in the stacking direction.

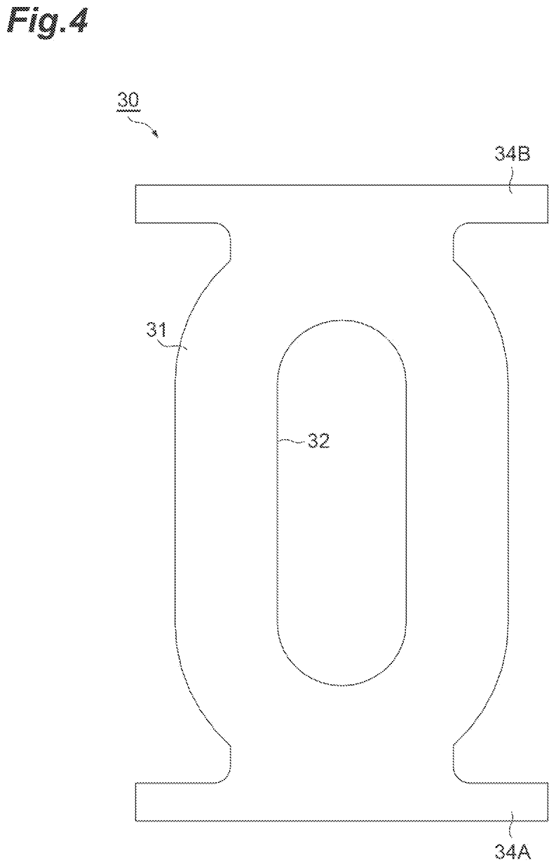

The magnetic sheet 30 has a flat plate shape (for example, a sheet shape or a layer shape), extends between the end surfaces 10a and 10b of the element body 10, and is designed to be orthogonal to the end surfaces 10a and 10b. The magnetic sheet 30 extends in parallel to the upper surface 10c and the lower surface 10d of the element body 10. As shown in FIG. 4, the magnetic sheet 30 includes an elliptical ring-shaped coil overlapping portion 31 extending along the long-side direction of the element body 10, and a pair of frame portions 34A and 34B extending along the short-side direction of the element body 10 and sandwiching the coil overlapping portion 31 from both sides. An elliptical opening 32 extending along the long-side direction of the element body 10 is provided in a central portion of the coil overlapping portion 31. The thickness t of the magnetic sheet 30 can be designed to be, for example, 10 to 100 μm (as an example, 30 μm).

The magnetic sheet 30 is made of a magnetic material. In the present embodiment, the magnetic sheet 30 is configured to include resin and magnetic powder (magnetic material powder), and has a configuration in which the magnetic powder is dispersed in the resin. The resin of the magnetic sheet 30 is, for example, an epoxy resin. The magnetic powder of the magnetic sheet 30 may be made of, for example, ferrite, permalloy, sendust, an Fe-based magnetic material, or the like. The magnetic powder of the magnetic sheet 30 may have a flat shape, a needle shape, or a spherical shape. For example, when the magnetic powder of the magnetic sheet 30 has a flat shape, the magnetic powder may extend in a direction intersecting the thickness direction of the magnetic sheet 30 (for example, a direction orthogonal to the thickness direction of the magnetic sheet 30). The magnetic sheet 30 may be an amorphous foil, an amorphous ribbon, or an amorphous layer made of a magnetic material.

The magnetic sheet 30 according to the present embodiment has a configuration in which flat ferrite powder is substantially uniformly dispersed in epoxy resin, and the flat ferrite powder extends in a direction orthogonal to the thickness direction of the magnetic sheet 30. Therefore, the magnetic permeability of the magnetic sheet 30 in the direction orthogonal to the thickness direction is higher than that in the thickness direction. In addition, since the ferrite flat powder extends substantially parallel to the extending direction of the magnetic sheet 30, the magnetic permeability is increased while suppressing an increase in thickness of the magnetic sheet 30.

As shown in FIG. 3, the upper coil structure 40A is provided on the sheet upper surface 30a of the coil overlapping portion 31 of the magnetic sheet 30. The upper coil structure 40A includes an insulating layer 30A, a first upper planar coil 41, a second upper planar coil 42, a first upper insulator 51, and a second upper insulator 52.

The insulating layer 30A has a flat plate shape (for example, a sheet shape or a layer shape) and extends parallel to the magnetic sheet 30. The insulating layer 30A has substantially the same shape as the magnetic sheet 30 when viewed from the thickness direction. That is, similarly to the magnetic sheet 30, the insulating layer 30A includes an elliptical ring-shaped coil overlapping portion 31 extending along the long-side direction of the element body 10, and a pair of frame portions 34A and 34B extending along the short-side direction of the element body 10 and sandwiching the coil overlapping portion 31 from both sides. The insulating layer 30A can be designed to have a depth t1 of, for example, 10 to 50 μm (15 μm as an example). The insulating layer 30A is made of an insulating material, for example, a resinous material such as BT resin.

The first upper planar coil 41 is a substantially oval spiral air-core coil wound around the opening 32 of the coil overlapping portion 31 in the same layer on the upper surface 30A of the insulating layer 30A. The first upper planar coil 41 has a coil axis Z along the thickness direction of the element body 10. The number of turns of the first upper planar coil 41 may be one or a plurality of turns. In the present embodiment, the number of turns of the first upper planar coil 41 is two to three. The first upper planar coil 41 has an outer end portion 41a and an inner end portion 41b. The outer end portion 41a is provided on the frame portion 34A, extends to the end surface 10a of the element body 10, and is exposed from the end surface 10a. The inner end portion 41b is provided at an edge of the opening 32. In the insulating layer 30A, a through conductor 47 extending in the thickness direction of the insulating layer 30A is provided at a position overlapping the inner end portion 41b of the first upper planar coil 41 so as to penetrate the insulating layer 30A. The first upper planar coil 41 is made of Cu, for example, and can be formed by electrolytic plating. In the present embodiment, the first upper planar coil 41 has an auxiliary outer end portion 41c that overlaps an outer end portion 42a of a second upper planar coil 42 described later with an insulating layer 30A interposed therebetween. The auxiliary outer end portion 41c is electrically connected to the outer end portion 42a via a through conductor (not shown) passing through the insulating layer 30A. By providing the auxiliary outer end portion 41c and making the outer end portion have a double structure, contact areas between the outer end portion and the external terminal electrodes are increased, and connectivity is improved.

The second upper planar coil 42 is symmetrical to the first upper planar coil 41. More specifically, the second upper planar coil 42 has a shape obtained by inverting the shape of the first upper planar coil 41 around an axis parallel to the short side of the element body 10. The second upper planar coil 42 shares the coil axis Z with the first upper planar coil 41. The outer end portion 42a of the second upper planar coil 42 is provided on the frame portion 34B, extends to the end surface 10b of the element body 10, and is exposed from the end surface 10b. The inner end portion 42b of the second upper planar coil 42 overlaps the through conductor 47 provided in the insulating layer 30A. Therefore, the inner end portion 42b of the second upper planar coil 42 is electrically connected to the inner end 41b of the first upper planar coil 41 via the through conductor 47. The second upper planar coil 42 is made of Cu, for example, and can be formed by electrolytic plating. In the present embodiment, the second upper planar coil 42 has an auxiliary outer end portion 42c that overlaps the outer end portion 41a of the first upper planar coil 41 with the insulating layer 30A interposed therebetween. The auxiliary outer end portion 42c is electrically connected to the outer end portion 41a via a through conductor (not shown) passing through the insulating layer 30A. By providing the auxiliary outer end portion 42c and making the outer end portion have a double structure, contact areas between the outer end portion and the external terminal electrodes are increased, and connectivity is improved.

The thickness T41 of the first upper planar coil 41 and the thickness T42 of the second upper planar coil 42 can be designed to be in a range of 20 to 40 μm, for example (as an example, 30 μm). The thickness T41 of the first upper planar coil 41 and the thickness T42 of the second upper planar coil 42 may be the same or different. In the upper coil structure 40A, the first upper planar coil 41, the second upper planar coil 42, and the through conductor 47 provided in the insulating layer 30A constitute a first coil C1 having a coil axis Z.

The first upper insulator 51 and the second upper insulator 52 cover the insulating layer 30A, the first upper planar coil 41, and the second upper planar coil 42 so as to sandwich the insulating layer SL, the first upper planar coil 41, and the second upper planar coil 42. Both the first upper insulator 51 and the second upper insulator 52 are made of insulating resin. The first upper insulator 51 and the second upper insulator 52 are both made of an insulating resin, and may be made of a PP resin or a BT resin, for example. The first upper insulator 51 and the second upper insulator 52 may be composite members (so-called prepregs) containing resin and glass fiber. The first upper insulator 51 and the second upper insulator 52 can be formed by, for example, vacuum pressing an insulating resin sheet from the thickness direction of the element body 10. As a result, the spaces between the wires of the first upper planar coil 41 and the second upper planar coil 42 are filled with the resin material, and the inner surfaces and the outer surfaces of the first upper planar coil 41 and the second upper planar coil 42 are covered with the resin material.

The thickness T51 of the first upper insulator 51 and the thickness T52 of the second upper insulator 52 can be designed to be, for example, in a range of 40 to 50 μm (45 μm as an example). The thickness T51 of the first upper insulator 51 and the thickness T52 of the second upper insulator 52 may be the same or different.

As shown in FIG. 3, the lower coil structure 40B is provided on the sheet lower surface 30b of the coil overlapping portion 31 of the magnetic sheet 30. The lower coil structure 40B includes an insulating layer 30B, a first lower planar coil 43, a second lower planar coil 44, a first lower insulator 53, and a second lower insulator 54.

The insulating layer 30B of the lower coil structure 40B has a flat plate shape (for example, a sheet shape or a layer shape) like the insulating layer 30A of the upper coil structure 40A, and extends in parallel to the magnetic sheet 30. The insulating layer 30B has substantially the same shape as the magnetic sheet 30 when viewed from the thickness direction. Similarly to the magnetic sheet 30 and the insulating layer 30B, the insulating layer 30A includes an elliptical ring-shaped coil overlapping portion 31 extending along the long-side direction of the element body 10 and a pair of frame portions 34A and 34B extending along the short-side direction of the element body 10 and sandwiching the coil overlapping portion 31 from both sides. The insulating layer 30B can be designed to have a depth t2 of, for example, 10 to 50 μm (15 μm as an example). The thickness t2 of the insulating layer 30B may be the same as or different from the thickness t1 of the insulating layers 30A. The insulating layer 30B is made of an insulating material similarly to the insulating layer 30A, and may be made of, for example, a plastic material such as t resin.

The first lower planar coil 43 is a substantially oval spiral air-core coil wound around the opening 32 of the coil overlapping portion 31 in the same layer on the upper surface 30a of the insulating layer 30B. The first lower planar coil 43 shares the coil axis Z with the upper planar coils 41 and 42. The number of turns of the first lower planar coil 43 may be one turn or a plurality of turns. In the present embodiment, the number of turns of the first lower planar coil 43 is two to three. The first lower planar coil 43 has an outer end portion 43a and an inner end portion 43b. The outer end portion 43a is provided on the frame portion 34A, extends to the end surface 10a of the element body 10, and is exposed from the end surface 10a. The inner end portion 43b is provided at an edge of the opening 32. In the insulating layer 30B, a through conductor 48 extending in the thickness direction of the insulating layer 30B is provided at a position overlapping the inner end portion 43b of the first lower planar coil 43 so as to penetrate the insulating layer 30B. The first lower planar coil 43 is made of Cu, for example, and can be formed by electrolytic plating. In the present embodiment, the first lower planar coil 43 has an auxiliary outer end portion 43c that overlaps an outer end portion 44a of a second lower planar coil 44 described later with an insulating layer 30B interposed therebetween. The auxiliary outer end portion 43c is electrically connected to the outer end portion 44a via a through conductor (not shown) passing through the insulating layer 30B. By providing the auxiliary outer end portion 43c and making the outer end portion have a double structure, contact areas between the outer end portion and the external terminal electrodes are increased, and connectivity is improved.

The second lower planar coil 44 is symmetrical to the first lower planar coil 43. More specifically, the second lower planar coil 44 has a shape obtained by inverting the shape of the first lower planar coil 43 around an axis parallel to the short side of the element body 10. The second lower planar coil 44 shares the coil axis Z with the upper planar coils 41 and 42 and the first lower planar coil 43. The outer end portion 44a of the second lower planar coil 44 is provided on the frame portion 34B, extends to the end surface 10b of the element body 10, and is exposed from the end surface 10b. The inner end portion 44b of the second lower planar coil 44 overlaps the through conductor 48 provided in the insulating layer 30B. Therefore, the inner end portion 44b of the second lower planar coil 44 is electrically connected to the inner end portion 43b of the first lower planar coil 43 via the through conductor 48. The second lower planar coil 44 is made of Cu, for example, and can be formed by electrolytic plating. In the present embodiment, the second lower planar coil 44 has an auxiliary outer end portion 44c that overlaps the outer end portion 43a of the first lower planar coil 43 with the insulating layer 30B interposed therebetween. The auxiliary outer end portion 44c is electrically connected to the outer end portion 43a via a through conductor (not shown) passing through the insulating layer 30B. By providing the auxiliary outer end portion 44c and making the outer end portion have a double structure, contact areas between the outer end portion and the external terminal electrodes are increased, and connectivity is improved.

The thickness T43 of the first lower planar coil 43 and the thickness T44 of the second lower planar coil 44 can be designed to be, for example, in a range of 20 to 40 μm (30 μm as an example). The thickness T43 of the first lower planar coil 43 and the thickness T44 of the second lower planar coil 44 may be the same or different. In the lower coil structure 40B, the first lower planar coil 43, the second lower planar coil 44, and the through conductor 48 provided in the insulating layer 30B constitute a second coil C2 having a coil axis Z.

The first lower insulator 53 and the second lower insulator 54 cover the insulating layer 30B, the first lower planar coil 43, and the second lower planar coil 44 so as to sandwich them in the thickness direction of the element body 10. Both the first lower insulator 53 and the second lower insulator 54 are made of an insulating resin. Each of the first lower insulator 53 and the second lower insulator 54 is made of insulating resin, and may be made of PP resin or BT resin, for example. The first lower insulator 53 and the second lower insulator 54 may be composite members (so-called prepregs) containing resin and glass fiber. The first lower insulator 53 and the second lower insulator 54 can be formed by, for example, vacuum pressing an insulating resin sheet from the thickness direction of the element body 10. As a result, the spaces between the wires of the first lower planar coil 43 and the second lower planar coil 44 are filled with the resin material, and the inner surfaces and the outer surfaces of the first lower planar coil 43 and the second lower planar coil 44 are covered with the resin material.

The thickness T53 of the first lower insulator 53 and the thickness T54 of the second lower insulator 54 can be designed to be, for example, in a range of 40 to 50 μm (45 μm as an example). The thickness T53 of the first lower insulator 53 and the thickness T54 of the second lower insulator 54 may be the same or different.

The two pairs of external terminal electrodes 60A, 60B, 60C, and 60D are provided in pairs on end surfaces 10a and 10b of the element body 10 that are parallel to each other.

Of the pair of external terminal electrodes 60A and 60B provided on the end surface 10a, the external terminal electrode 60A is connected to the outer end portion 43a of the first lower planar coil 43 of the lower coil structure 40B, and the external terminal electrode 60B is connected to the outer end portion 41a of the first upper planar coil 41 of the upper coil structure 40A. When viewed from the end surface 10a side, the external terminal electrode 60A is biased toward the side surface 10f side and covers the end surface 10a up to the vicinity of the side surface 10f. The external terminal electrode 60B is biased to the side surface 10e side, and covers the end surface 10a up to the vicinity of the side surface 10e. When viewed from the end surface 10a side, the external terminal electrode 60A and the external terminal electrode 60B are separated by a predetermined uniform width.

Of the pair of external terminal electrodes 60C and 60D provided on the end surface 10b, the external terminal electrode 60C is connected to the outer end portion 44a of the second lower planar coil 44 of the lower coil structure 40B, and the external terminal electrode 60D is connected to the outer end portion 42a of the second upper planar coil 42 of the upper coil structure 40A. The external terminal electrode 60C is biased to the side surface 10f side and covers the end surface 10b up to the vicinity of the side surface 10f. The external terminal electrode 60D is biased to the side surface 10e side, and covers the end surface 10b up to the vicinity of the side surface 10e. When viewed from the end surface 10b side, the external terminal electrode 60C and the external terminal electrode 60D are separated by a predetermined uniform width.

The external terminal electrode 60A of the end surface 10a and the external terminal electrode 60C of the end surface 10b are provided at positions corresponding to each other in the long-side direction of the element body 10. Similarly, the external terminal electrode 60B on the end surface 10a and the external terminal electrode 60D on the end surface 10b are provided at positions corresponding to each other in the long-side direction of the element body 10.

Each of the external terminal electrodes 60A, 60B, 60C, and 60D is bent in an L shape and continuously covers the end surfaces 10a and 10b and the upper surface 10c. In the present embodiment, the external terminal electrodes 60A, 60B, 60C, and 60D are made of resinous electrodes, for example, made of resins containing Ag powder.

In the coil component 1, when a voltage is applied between the external terminal electrode 60B and the external terminal electrode 60D, a current flows through the first coil 40A of the upper coil structure C1, and magnetic fluxes are generated around the first coil C1. Similarly, when a voltage is applied between the external terminal electrode 60A and the external terminal electrode 60C, a current flows through the second coil 40B of the lower coil structure C2, and magnetic fluxes are generated around the second coil C2. At this time, magnetic coupling may occur between the first coil C1 and the second coil C2 that share the coil axes Z.

In the magnetic sheet 30 in the coil component 1, as shown in FIG. 4, the coil overlapping portion 31 overlapping the coils C1 and C2 has an elliptical ring shape, and both the portion corresponding to the inner peripheral region of the coils C1 and C2 and the portion corresponding to the outer peripheral region of the coils C1 and C2 are omitted. Therefore, both portions are filled with the magnetic materials constituting the element body 10 to constitute the inner core and the outer core of the coil C1 and the C2. The magnetic sheet 30 may have a form in which only one of a portion corresponding to the inner peripheral region of the coil C1 or C2 and a portion corresponding to the outer peripheral region of the coil C1 or C2 is omitted.

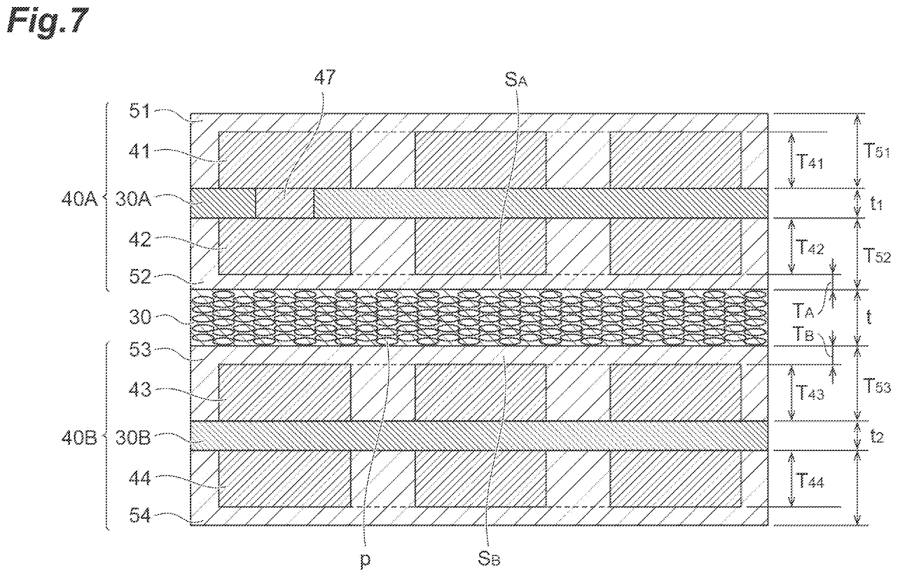

In the coil component 1, leakage flux (that is, flux passing through only the first coil C1 and flux passing through only the second coil C2) is likely to be generated by the magnetic sheet 30 interposed between the first coil C1 and the second coil C2. The coupling coefficient can be adjusted by increasing or decreasing the leakage magnetic flux by the magnetic sheet 30. For example, by increasing the magnetic permeability of the magnetic sheet 30, the leakage magnetic flux can be increased and the coupling coefficient can be decreased. In addition, the magnetic permeability of the magnetic sheet 30 can be increased by increasing the thickness of the magnetic sheet 30. In the present embodiment, the magnetic sheet 30 is designed to be thicker than the thicknesses T_{A} and T_{B} of the insulators 52 and 53 in the portions (portions S_{A} and S_{B} shown in FIG. 7) interposed between the magnetic sheet 30 and the coils C1 and C2. In the present embodiment, the magnetic permeability of the magnetic sheet 30 is designed to be higher than the magnetic permeability of the element body material (that is, the metal magnetic powder-containing resin 12) constituting the element body 10 and higher than the magnetic permeability of the insulators 52 and 53 adjacent to the magnetic sheet 30 in the thickness direction. In particular, by increasing the magnetic permeability in the surface direction of the magnetic sheet 30 (the direction orthogonal to the coil axis Z), the leakage magnetic flux is effectively increased. The magnetic permeability of the magnetic sheet 30 can be adjusted by, for example, the thickness of the magnetic sheet 30, the form of the magnetic powder, the type of the magnetic powder, the content ratio of the magnetic powder, or the like.

In the present embodiment, as shown in FIG. 7, the magnetic powder p contained in the magnetic sheet 30 has a flat shape, and each magnetic powder extends along the surface direction of the magnetic sheet 30. In such a magnetic sheet 30, the magnetic permeability in the plane direction is relatively higher than the magnetic permeability in the thickness direction.

As described above, the coil component 1 is provided in the element body 10, and includes the pair of coils C1 and C2 overlapping each other in the coil-axis Z direction, the magnetic sheet 30 interposed between the pair of coils C1 and C2 in the coil-axis Z direction, and the insulators 52 and 53 interposed between the pair of coils C1 and C2 and the magnetic sheet 30. Note that only one of the insulators 52 and 53 may be provided.

In the coil component 1, the coupling coefficient can be adjusted by the magnetic sheet 30 and the insulators 52 and 53 interposed between the pair of coils C1 and C2. For example, the permeability of the magnetic sheet 30 is increased to allow magnetic fluxes generated in the coils C1 and C2 to easily pass through the magnetic sheet 30, thereby reducing the coupling coefficient.

Even in a configuration in which a non-magnetic substrate such as a PCB substrate is interposed between the coils C1 and C2, it is possible to reduce the coupling coefficient by thickening the substrate. However, in this case, the element body 10 becomes thick, resulting in an increase in the size of the element body 10.

In the coil component 1 described above, the coupling coefficient can be adjusted while the thickness of the element body 10 is suppressed.

It should be noted that the present disclosure is not limited to the above-described embodiment and may take various forms. For example, the number of turns of the planar coil constituting the coil can be increased or decreased as appropriate. In addition, three or more coils may be included in the element body.

What is claimed is:

1. A coil component comprising:
an element body made of a metal powder-containing resin;
a pair of coils provided in the element body, the pair of coils overlap each other in a coil axis direction, and each of the pair of coils has a pair of end portions extending to a surface of the element body;
two pairs of external terminals provided on the surface of the element body and connected to the end portions of the pair of coils, respectively;
a magnetic sheet provided in the element body and interposed between the pair of coils in the coil axis direction;
an insulator interposed between at least one of the pair of coils and the magnetic sheet.

2. The coil component according to claim 1, wherein the magnetic sheet is made of a magnetic material containing magnetic powder and resin.

3. The coil component according to claim 1, wherein the magnetic powder of the magnetic sheet has a flat shape.

4. The coil component according to claim 1, wherein a thickness of the magnetic sheet is greater than a thickness of a portion of the insulator interposed between the magnetic sheet and the coil.

5. The coil component according to claim 1, wherein a magnetic permeability of the magnetic sheet is higher than a magnetic permeability of the element body.

6. The coil component according to claim 1, wherein at least one of a portion corresponding to an inner peripheral region of the coil and a portion corresponding to an outer peripheral region of the coil is omitted from the magnetic sheet.
